(19) United States
(12) Patent Application Publication
(10) Pub. No.: US 2014/0270219 A1
(43) Pub. Date: Sep. 18, 2014

(54) METHOD, APPARATUS, AND MANUFACTURE FOR BEAMFORMING WITH FIXED WEIGHTS AND ADAPTIVE SELECTION OR RESYNTHESIS

(71) Applicant: CSR TECHNOLOGY, INC., Sunnyvale, CA (US)

(72) Inventors: Tao Yu, Rochester Hills, MI (US); Rogerio G. Alves, Macomb Township, MI (US)

(21) Appl. No.: 13/842,911

(22) Filed: Mar. 15, 2013

(51) Int. Cl. H04R 3/00

(52) U.S. Cl. CPC H04R 3/002
USPC 381/71.1

(57) ABSTRACT

A method, apparatus, and manufacture for beamforming is provided. Parameters based on sets of pre-determined beamforming weights are stored. Each of the sets of pre-determined beamforming weights has a corresponding integral index number. Each input microphone signal is transformed to the frequency domain to provide a corresponding transformed signal. Each of the transformed signals includes a plurality of subbands. Next, an index number is determined representing an optimal set of beamforming weights for the transformed signals. Then, a set of beamforming weights is applied to each subband of each of the transformed signals to provide a weighted signal. The set corresponds to the determined index number. A time domain signal is then provided by combining each of the weighted signals.

### TECHNICAL FIELD

The invention is related to beamforming, and in particular, but not exclusively, to a method, apparatus, and manufacture for beamforming in which the beamforming weights to be used are either selected adaptively or re-synthesized adaptively from a set of fixed beamforming weights.

### BACKGROUND

Beamforming is a signal processing technique for directional reception or transmission. In reception beamforming, sound may be received preferentially in some directions over others. Beamforming may be used in an array of two or more microphones, for example to ignore noise in one particular direction while listening to speech from another direction.

### BRIEF DESCRIPTION OF THE DRAWINGS

Non-limiting and non-exhaustive embodiments of the present invention are described with reference to the following drawings, in which:

FIG. 1 illustrates a block diagram of an embodiment of a system;

FIG. 2 shows a block diagram of an embodiment of the microphone array of FIG. 1;

FIG. 3 illustrates a flowchart of a method that may be employed by an embodiment of the system of FIG. 1;

FIG. 4 shows a functional block diagram of an embodiment of a switchable fixed beamformer that may be implemented in an embodiment of the system of FIG. 2;

FIG. 5 illustrates a plot of magnitude of the beamforming output signal over direction of arrival for different sets of weights for an embodiment in which different null beamforming patterns are switched discretely;

FIG. 6 illustrates a plot of magnitude of the beamforming output signal over direction of arrival for different sets of weights for an embodiment in which beampatterns with different looking directions are switched discretely;

FIG. 7 shows a polar plot for different sets of weights for an embodiment in which different end-fire directivity beampatterns are switched discretely;

FIG. 8 illustrates a plot of magnitude of the beamforming output signal over direction of arrival for different sets of weights for an embodiment in which beampatterns for different levels of diagonal loading are switched discretely;

FIG. 9 shows two plots of weights of index in which weights between pre-designed weights are obtained through polynomial interpolation;

FIG. 10 illustrates a polar plot of beampatterns of discrete directivity beamforming;

FIG. 11 shows a polar plot of synthesized beampatterns for an embodiment of two-microphone switchable continuous beamforming; and

FIG. 12 illustrates a flowchart of embodiments of the process of FIG. 3, in accordance with aspects of the invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may. Similarly, the phrase “in some embodiments,” as used herein, when used multiple times, does not necessarily refer to the same embodiments, although it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. The term “signal” means at least one current, voltage, charge, temperature, data, or other signal.

Briefly stated, the invention is related to a method, apparatus, and manufacture for beamforming. Parameters based on sets of pre-determined beamforming weights are stored (e.g., the weights themselves, or an interpolation function and coefficients based on the weights). Each of the sets of pre-determined beamforming weights has a corresponding integral index number. Each input microphone signal is transformed to the frequency domain to provide a corresponding transformed signal. Each of the transformed signals includes a plurality of subbands. Next, an index number is determined representing an optimal set of beamforming weights for the transformed signals. Then, a set of beamforming weights is applied to each subband of each of the transformed signals to provide a weighted signal (in some embodiments, the weights are re-synthesized from the interpolation function before being applied). The set corresponds to the determined index number. A time domain signal is then provided by combining each of the weighted signals.

FIG. 1 shows a block diagram of an embodiment of system 100. System 100 includes microphone array 102, A/D converter(s) 103, processor 104, and memory 105.

In operation, microphone array 102 receives sound via two or more microphones (not shown in FIG. 1) in microphone array 102, and provides microphone signal(s) MAout in response to the received sound. A/D converter(s) 103 converts microphone signal(s) MAout into input microphone signals IM to be input to the beamforming algorithm.

Processor 104 receives input microphone signals IM, and, in conjunction with memory 105, performs a beamforming algorithm to provide beamforming output Y from input microphone signals IM. In some embodiments, the beamforming algorithm is provided in accordance with processor-executable instructions stored in memory 105 fetched by processor 104. Memory 105 may be a processor-readable medium which stores processor-executable code encoded on the processor-readable medium, where the processor-executable code, when executed by processor 104, enable actions to performed in accordance with the processor-executable code.

Memory 105 stores parameters that are based, at least in part, on sets of pre-determined beamforming weights, where each of the sets of pre-determined beamforming weights has a corresponding integral index number. For example, memory 105 may store a set of Ξ pre-designed beam patterns or beamforming modes, where the corresponding set of beamforming weights can be written as,

wε{w(ξ),ξ=1,2, . . . Ξ},

where ξ is defined as the index number of the weight in this set. In other embodiments, as discussed in greater detail below, memory 105 stores an interpolation function and coefficients of the interpolation function.

While performing beamforming, processor 104 determines an index number representing the optimal set of beamforming weights for the signals, and uses this index number for the beamforming, as discussed in greater detail below. In some embodiments, processor 104 selects an optimal integral index number that corresponds to a stored set of beamforming weights, and in other embodiments, processor 104 can also select an optimal index number that is not an integer and the beamforming weights are re-synthesized by means of the stored interpolation function, as discussed in greater detail below.

Although FIG. 1 illustrates a particular embodiment of system 100, other embodiments may be employed with the scope and spirit of the invention. For example, many more components than shown in FIG. 1 may also be included in system 100 in various embodiments. For example, in some embodiments, system 100 may further include a digital-to-analog converter to converte the output signal Y to an analog signal. Alternatively, in other embodiments, system 100 may maintain output signal Y as a digital signal and performing further processing on the digital signal. Also, although FIG. 1 depicts an embodiment in which the beamforming is performed in software, in other embodiments, the beamforming may instead be performed by hardware, or some combination of hardware and/or software. These embodiments and others are within the scope and spirit of the invention.

FIG. 2 shows a block diagram of an embodiment of microphone array 202, which may be employed as an embodiment of microphone array 102 of FIG. 1. Microphone array 102 includes M microphones.

In one scenario, a single desired speech source impinges on the array of M microphones, as illustrated in FIG. 2. Returning to FIG. 1, in some embodiments, processor 104 may be employed to take the Short-Time Fourier Transform (STFT) of the time domain signal, where the signal model in each time-frame and frequency-bin (or subband) can be written as,

x(t,k)=a(t,k,θₓ)s)(t,k)+n(t,k),

where xεC^{Mxi} is the array observation signal vector (e.g., noisy speech), sεC is the desired speech, nεC^{Mxi} represents the background noise plus interference, and t and k are the time-frame index and frequency-bin (subband) index, respectively. The array steering vector aεC^{Mxi} is a function of the direction-of-arrival (DOA) θₛ of the desired speech.

With the assumption that the signal components are mutually uncorrelated, the correlation matrix of the observed signal vector in the k′h frequency-bin can be expressed as,

Rₓₓ(k)=E{x(t,k)x^{H}(t,k)}=Rₛₛ(k)+Rₙₙ(k),

where RₛₛεC^{M×M} and RₙₙεC^{M×M} are the correlation matrices for the desired speech and noise, respectively.

Where the beamforming is performed as a linear processor (filter) for each subband consisting of a set of complex weights, the output of the beamformer is an estimation of the desired speech, given by,

y(t,k)=\hat{s}(t,k)=w^{H}(t,k)x(t,k),

where the beamformer weights w can be computed using some optimization criterion, such as the Minimum Mean Square Error (MMSE), the Minimum Variance Distortion-less Response (MVDR), or the Maximum Signal-to-Noise Ratio (Max-SNR). The optimal weights may be presented in the following form,

w(t,k)=ξ(k)Rₙₙ⁻¹(k)a(t,k,θₛ),

where ξ is a scale factor that is dependent on the optimization criterion in each of the frequency bins.

The enhanced speech signal can be obtained by substitution, i.e.,

y(t,k)=ŝ(t,k)=w^{H}(t,k)a(t,k,θₛ)s(t,k)+w^{H}(t,k)n(t,k),

To obtain distortion-less enhancement of the target speech, so that no artifacts are introduced into the target speech within the beamforming process, the beamformer weights should satisfy the following constraint:

w^{H}(t,k)a(t,k,θₛ)=1.

Accordingly, the beamforming estimation of the desired speech becomes,

y(t,k)=ŝ(t,k)=s(t,k)+w^{H}(t,k)n(t,k).

At the beamformer output, the desired speech may be totally preserved without any impairment, while the noise part may be reduced through (adaptive) adjustment of the beamforming weights.

FIG. 3 illustrates a flowchart of an embodiment of a process (350) of beamforming. After a start block, the process proceeds to block 351, where parameters based, at least in part, on sets of pre-determined beamforming weights are stored. Each of the sets of pre-determined beamforming weights has a corresponding integral index number.

The process then moves to block 352, where each input microphone signal is transformed to the frequency domain to provide a corresponding transformed signal. Each of the transformed signals includes a plurality of subbands. The process then advances to block 354, where an index number is determined representing an optimal set of beamforming weights to be applied to the transformed signals.

The process then proceeds to block 355, where a set of beamforming weights is applied to each subband of each of the transformed signals to provide a weighted signal. The set of weights applied corresponds to the determined index number. The process then moves to block 356, where a time domain signal is provided by combining each of the weighted signals with each other. The process then advances to a return block, where other processing is resumed.

At the step at block 351, the pre-determined beamforming weights may be determined by the customer in some embodiments. The weights may be employed for various reasons in various embodiments and modes.

For example, in some embodiments, each index number corresponds to a particular angular direction of arrival in which the beampattern forms a null in order to suppress noise from that direction. This is an example of null beamforming patterns. In this example, each different index number may correspond to a different angular direction of arrival for which the beampattern forms a null. Other beampatterns that may be employed may include, for example, beampatterns with different looking directions; beampatterns for different levels of diagonal loading; and beampatterns for different directivity beampatterns such as omnidirectional, cardiod, supercardiod, hypercardiod, and dipole beampatterns. Each of these examples in discussed in greater detail below.

In some embodiments, the parameters stored at block 351 are the pre-determined beamforming weights themselves. In other embodiments, the parameters are an interpolation function and coefficients for the interpolation function, as discussed in greater detail below.

At the step at block 352, in some embodiments, a STFT may be used to transform the time domain signals into frequency domain signals.

At the step at block 354, an index number representing an optimal set of beamforming weights for the transformed signals may be selected based on some criterion/criteria.

In some embodiments, an integral index number from among each of the index numbers that correspond to one of the stored sets of pre-determined beamforming weights is selected based on a cost function formulated from an appropriate criterion, such as such as the minimal mean square error (MMSE), minimal variance distortion-less response (MVDR), maximal output signal-to-noise ratio (Max-SNR), maximal non-Gaussianity of the output, and/or or other criteria defined by the designer.

In other embodiments, the beamforming weights may be optimized from a cost function, and beamforming weights can be synthesized from a stored interpolation function. In this way, the optimized index number may be non-integral. These embodiments are discussed in further detail below.

FIG. 4 shows a functional block diagram of an embodiment of a switchable fixed beamformer 460 that may be implemented in software in an embodiment of system 200 of FIG. 2. Beamformer 460 includes sets of weights 461, comparator block 462, and switch 463.

For different conditions, different modes from the pre-designed beamforming weights set 461 may be employed, according to a certain cost function, e.g.,

j(w,x).

This cost function can be formulated from an appropriate criterion, such as the minimal mean square error (MMSE), minimal variance distortion-less response (MVDR), maximal output signal-to-noise ratio (Max-SNR), maximal non-Gaussianity of the output, and/or other criteria defined by the designer. Since the sets of beamforming weights 461 are pre-designed and fixed, a beamforming mode can determined by the index number ξ, and accordingly the cost function is a function of the index number ξ (e.g.,

j(w,x)=J(ξ,x).

For a real-time processing, the beamforming mode may switch (463) from one index number to another, causing the beamforming weight to be updated within the set of weights 461. The cost function in and the decision criterion can be realized as illustrated in FIG. 4 where comparator 462 (e.g., power comparator) compares the output power of different beamforming outputs and the beamforming index number is chosen by maximizing the power of output signal γout.

As discussed above, in various embodiments, the sets of weights may be employed to accomplish things in different embodiments.

For example, in some embodiments, the weights may be employed to switch between candidate null directions. In some cases, the target speech is coming from a fixed direction and the interference noise may come from a certain range of possible directions. In order to suppress the noise, a beamformer may be employed to form a beam pattern with a null towards the direction of noise. Instead of designing a beamformer that has a null wide enough to cover all the possible directions of the interference, a set of beamforming weights may be pre-designed in which each of the sets forms a narrower but deeper null towards one of the possible noise directions, as illustrated in FIG. 5.

FIG. 5 illustrates a plot of dB over direction of arrival for different sets of weights for an embodiment in which different null beamforming pattern are switched discretely. In a real-time processing, the beamforming weight can be adaptively selected from this pre-designed set according to the minimal output power criterion. This mechanism can be mathematically formulated as,

ξ*=argmin{∥w^{H}(ξ)x|²}, ξ=1,2, . . . Ξ

The switching mechanism can be realized by one or multiple power comparators 462 that generate the index of the beamforming weight which outputs the smallest power.

In some embodiments, the weights may be employed to switch (463) between beampatterns with different looking directions. For example, in some cases, the noise field is approximately fixed while the target speech may come from an unknown direction within a confined range. Accordingly, a set of MVDR beamforming weights can be pre-designed with partially overlapped looking-direction covering each of the possible incoming directions of target speech, as illustrated FIG. 6.

FIG. 6 illustrates a plot of dB over direction of arrival for different sets of weights for an embodiment in which beampatterns with different looking directions are switched discretely. During run-time, the optimal beamforming weight is chosen from this pre-designed set. To identify the beamforming weight that generates the undistorted target speech, a non-Gaussianity criterion may be used. This mechanism may be mathematically formulated as,

ξ′=argmin{non-Gaussianity(w^{H}(ξ)x)}, ξ=1,2, . . . Ξ,

where non-Gaussianity^{( )} is a function measuring the Non-Gaussianity of a given signal. One possible measure of Non-Gaussianity is Kurtosis, which is defined as:

K(y)=E{|y|⁴}−2(E{|y|²})²−|E{y²}|²,

for a complex signal y, and where E{ } denotes the operation of expectation.

As an alternative to Non-Gaussianity criterion, spectra flux (SF) or variance of spectral flux (VSF) also can be utilized. In some embodiments, an SF inspired criterion may be employed to identify the target speech from a music environment. This spectra flux criterion is more robust as compared with the non-Gaussianity criterion; accordingly, the spectra flux criterion also can be employed to identify the optimal beamforming weight in some embodiments.

In some embodiments, the weights may be employed to switch (463) between different end-fire directivity beampatterns. For example, for an end-fire microphone array, five beam patterns shown in FIG. 7 are commonly used in a directional processing system, such as hearing aid device and professional recording microphone. FIG. 7 shows a polar plot for different sets of weights for an embodiment in which different end-fire directivity beampatterns are switched discretely. Some embodiments may be employed to enable the beamformer to switch between some or all of these common beam patterns according to some criteria, such as best listening experiences, minimal noise power, and/or other criteria chosen by the designer.

In some embodiments, the weights may be employed to switch (463) between beampatterns for different levels of diagonal loading. Diagonal loading (DL) is method than may be employed to leverage between array gain and white noise gain, and also to improve the robustness of an MVDR beamformer. The level of DL may be adaptively optimized for different acoustic conditions. In some embodiments, a set of beamforming weights may be pre-designed to correspond to various DL levels. As an illustration, FIG. 8 shows the beam patterns formed by embodiments of these pre-designed beamforming weights.

FIG. 8 illustrates a plot of dB over direction of arrival for different sets of weights for an embodiment in which beampatterns for different levels of diagonal loading are switched discretely. The beamforming weight with an appropriate (or the optimal) DL level can be selected by the minimal output power criterion.

The discrete case discussed above is equivalent to having multiple, pre-designed, separate beamformers, where the selection of which of the separate beamformers to use is made adaptively, on the fly.

In some embodiments, the determining of which beamforming output to use is made repeatedly over time, so that a different beamforming output may be selected at a different time when the input data has changed so that a different beamforming output is optimal.

Several embodiments of the invention described above enable a beamformer to switch among different discrete and isolated beamforming modes and weights, which can be pre-designed for different cost functions and acoustic conditions. While this scheme is efficient and simple, it mainly has two drawbacks. First, the number of the pre-designed weights limits the beamforming degree-of-freedom; in other words, the variability of the beamformer is limited. Secondly, switching from one weight to another is a “hard” transition and may cause discontinuity in the output. Certain embodiments of the invention avoid these two problems by employing a continuously switchable fixed beamforming method.

For a set of pre-designed beamforming modes where the beamforming is a linear processor consisting of a set of complex weights, a (smooth) interpolation function ƒ that maps the index number ξ to the corresponding beamforming weights w(ξ) may be expressed as)

w(ξ)=ƒ(ξ), ξε{1,2,3, . . . Ξ}.

That is, for the index number ξ within the pre-defined index set {1, 2, 3, . . . Ξ}, w(1)=ƒ(1), w(2)=ƒ(2), . . . , w(Ξ)=ƒ(Ξ).

Alternatively, for ξ that is outside of the pre-defined index set, the corresponding weight w(ξ) can be generated/synthesized from the interpolation function ƒ. For example, if ξ=1.5, which is outside of the set of index, w(1.5) can be generated by (1.5). Accordingly, infinite beamforming weights can be synthesized from this interpolation function. Accordingly, the degree-of-freedom of the resulting beamformer is unlimited and the transition between two pre-designed modes can be smoothed by the synthesized beamforming weight.

In some embodiments, the interpolation function ƒ can be any function that minimizes the following mean square error,

$${\sum }_{ξ = 1}^{Ξ} {\vert f ( ξ ) - w ( ξ ) \vert}^{2} ,$$

and then the interpolation function can be solved by,

$${f}^{0} = \{ {\sum }_{ξ = 1}^{Z} {\vert f ( ξ ) - w ( ξ ) \vert}^{2} , \} .$$

The specific form of the interpolation function can be polynomial, exponential, Gaussian, and/or the like.

Different from the switching mechanism for the discrete case described above, a gradient based adaptive algorithm can be derived using the (smoothed) interpolation function ƒ. Just as for the discrete switching beamformer embodiment discussed above, a pre-defined cost function J may be employed,

J(ξ)=J(ƒ^{H}(ξ),x).

If the cost function J is smooth, the steepest-descent optimization method may be employed to iteratively update ξ, that is,

$${ξ}^{t + 1} = {ξ}^{t} \pm μ \frac{\partial J}{\partial ξ} ,$$

where μ is the step-size parameter and the operator of + or − is determined by maximization or minimization of the cost function J. The gradient

$$\frac{\partial J}{\partial ξ}$$

may be derived as,

$$\frac{\partial J}{\partial ξ} = \frac{\partial J}{\partial f} \cdot \frac{\partial f}{\partial ξ} + \frac{\partial J}{\partial {f}^{*}} \cdot \frac{\partial {f}^{*}}{\partial ξ} ,$$

After the optimization on ξ, the beamforming weights may be synthesized from the interpolation function as,

w^{t+1}=ƒ^{(ξt+1)}.

The output of the adaptive beamformer, accordingly, may be obtained as,

y=(w^{t+1})^{H}x.

Continuously switchable beamforming can be employed for each of the types of beampatterns discussed above for discrete switchable beamforming in various embodiments. As an example, the continuously switchable beamforming may be implemented to solve the problem of adaptive diagonal loading (DL). The diagonal loading noise correlation matrix can be written as,

Rₙₙ=r+ρI,

where ρ is the DL factor that controls the balance between array gain and white noise gain. With the assumption that the array steering vector of the target speech is fixed, the objective is to find a solution that can adaptively adjust the DL factor for the noise correlation matrix. In some embodiments, the criterion to optimize the DL factor can be chosen as the minimal output noise power.

In order to carry out the algorithm, the DL factor can be pre-defined as some discrete values within a certain range. That is, ρε{ρ(ξ), ξ=1, 2, 3, . . . , Ξ}. According to the MVDR previously shown, the optimal beamformer weights may be obtained as,

$${w}^{( ξ )} = \frac{1}{{a}^{H} ( {θ}_{s} ) {( r + {ρ}^{( ξ ) I} )}^{- 1} a ( {θ}_{s} )} {( r + {ρ}^{( ξ ) I} )}^{- 1} a ( {θ}_{s} ) ,$$

for each ξ in the set of the pre-defined index, where I is an identity matrix.

Next, the polynomial interpolation method may be used to find a smooth function f that maps the set of index ξ to the set of beamformer weights w(ξ), since the polynomial interpolation is one of the simplest interpolation methods.

The beamforming weight is a complex vector. Instead of mapping the index to the whole weights vector, the real part and imaginary part of each element in the weight vector can be interpolated by a single polynomial function. For example, dividing the weights vector into real part and imaginary part in each element as,

w=[w_{1,R}+jw_{1,I},w_{2,R}+jw_{2,I}, . . . ,w_{M,R}+jw_{M,I}];

For the real part of the m^{th} element in the weights vector,

$${w}_{m , r} ( ξ ) = {f}_{m , r} ( ξ ) = {\sum }_{l = 1}^{L} {β}_{m , R , 1} {ξ}^{l - 1} , \\ = {β}_{m , R , 1} + {β}_{m , R , 2} ξ + … + {β}_{m , R , 2} {ξ}^{L - 1} ,$$

where ƒ_{m,r} is a polynomial function, L−1 is the order of the polynomials, and β is the polynomial coefficient.

Following this formulation,

w_{1,R}(ξ)=ƒ_{1,R}(ξ)=β_{1,R,1}+β_{1,R,Z}ξ+ . . . +β_{1,R,L}ξ^{L-1},

w_{2,R}(ξ)=ƒ_{2,R}(ξ)=β_{2,R,1}+β_{2,R,2}ξ+ . . . +β_{2,R,L}ξ^{L-1},

w_{2,I}(ξ)=ƒ_{2,I}(ξ)=β_{2,I,1}+β_{2,I,2}ξ+ . . . +β_{2,I,L}ξ^{L-1},

and

w_{M,R}(ξ)=ƒ_{M,R}(ξ)=β_{M,R,1}+β_{M,R,2}ξ+ . . . +β_{M,R,L}ξ^{L-1}

w_{M,I}(ξ)=ƒ_{M,I}(ξ)=β_{M,I,1}+β_{M,I,2}ξ+ . . . +β_{M,I,L}ξ^{L-1}

for each of the element in the weight vector.

The interpolation function f, can be written into a vector form as,

$$f ( ξ ) = [ \begin{matrix}{f}_{1 , R} ( ξ ) + {jf}_{1 , I} ( ξ ) \\ {f}_{2 , R} ( ξ ) + {jf}_{2 , I} ( ξ ) \\ ⋮ \\ {f}_{M , R} ( ξ ) + {jf}_{M , I} ( ξ )\end{matrix} ] . \qquad ( 34 )$$

As an illustration, FIG. 9 plots the relation between the pre-designed weights and the interpolated/synthesized weights using polynomial interpolation. FIG. 9 shows two plots of weights of index for in which weights between pre-designed weights are obtained through polynomial interpolation. The discrete circles represent the pre-designed beamforming weights, and the curve shows the interpolated beamforming weights. As observed, using interpolation function ƒ, the set of beamforming weights are expanded to infinite; any point on the interpolated line can be employed as a new beamforming weight.

After obtaining the interpolation functions, the steepest-descent method may be employed to find the optimal beamforming index, which represents the best “point” on the interpolated curve shown in FIG. 9.

The steepest-descent method for optimization of beamforming index may be derived as follows.

For a polynomial function, the gradient may be computed as,

$$\frac{\partial {f}_{m , R}}{\partial ξ} = {\sum }_{l = 2}^{L} ( l - 1 ) {β}_{m , R , 1} {ξ}^{l - 2} .$$

As an example to adaptively updating beamforming weights, minimal output power criterion is used; that is,

J(ξ)=E{|w^{H}(ξ)x|²}=E{|ƒ^{H}(ξ)x|²},

The gradient can be obtained, as,

$$\frac{\partial J}{\partial ξ} = \frac{\partial J}{\partial f} \cdot \frac{\partial J}{\partial ξ} + \frac{\partial J}{\partial {f}^{H}} \cdot \frac{\partial {f}^{H}}{\partial ξ} , = 2 * Re \{ \frac{\partial J}{\partial f} \cdot \frac{\partial J}{\partial ξ} \} ,$$

where Re{ } is the operator of taking the real part. Accordingly,

$$\frac{\partial J}{\partial ξ} = {f}^{H} ( ξ ) E \{ x * {x}^{H} \} , \\ and$$

$$\frac{\partial J}{\partial ξ} = [ \begin{matrix}\frac{\partial {f}_{1 , R}}{\partial ξ} + j \frac{\partial {f}_{1 , I}}{\partial ξ} \\ \frac{\partial {f}_{2 , R}}{\partial ξ} + j \frac{\partial {f}_{2 , I}}{\partial ξ} \\ ⋮ \\ \frac{\partial {f}_{M , R}}{\partial ξ} + j \frac{\partial {f}_{M , I}}{\partial ξ}\end{matrix} ]$$

$$where$$

$$\frac{\partial {f}_{m , R}}{\partial ξ}$$

$$and$$

$$\frac{\partial {f}_{m , I}}{\partial ξ}$$

are given in previous equation. Accordingly, by substitution, the real-time updating iteration may be obtained as,

$${ξ}^{t + 1} = {ξ}^{t} - μ * 2 * Re \{ {f}^{H} ( {ξ}^{ t} ) x ( t ) * {x}^{H} ( t ) [ \begin{matrix}\frac{\partial {f}_{1 , R}}{\partial ξ} + j \frac{\partial {f}_{1 , I}}{\partial ξ} \\ \frac{\partial {f}_{2 , R}}{\partial ξ} + j \frac{\partial {f}_{2 , I}}{\partial ξ} \\ ⋮ \\ \frac{\partial {f}_{M , R}}{\partial ξ} + j \frac{\partial {f}_{M , I}}{\partial ξ}\end{matrix} ] \} .$$

After ξ is updated by the above equation, the new beamforming weights may be synthesized from the interpolation function as,

w^{t+1}=ƒ{ξ^{t+1}}.

Finally, the output of the adaptive beamformer, accordingly, may be obtained as,

y=(w^{t+1})^{H}ₓ.

Unlike the previously discussed discrete beampatterns, infinite and continuous beampatterns can be formed using the continuous approach. For example, the continuous case can be used for any of the discrete cases discussed above. The use of continuously switchable beamforming to solve the problem of adaptive diagonal loading was discussed above. Continuously switchable beamforming could also be used, for example, for switching between different null beamforming patterns.

The discussion above with regard to FIG. 5 discussed the use of beamforming to switch between five discrete beampatterns, in which the optimal output was selected from the five different patterns. For example, w(5) could be selected to cancel noise from a zero degree direction of arrival. Similarly, the weight w(4) could be selected to cancel noise from the −20 degree direction of arrival.

However, none of the five pre-designed beampatterns cancel noise from the −10 degree direction of arrival. In the discrete case, the algorithm could only select between w(4) and w(5), and select whichever beampattern was most optimal. However, in the continuously switchable beamforming embodiment, a curve could be selected to cancel noise at −10 degrees, by using interpolation to generate a beampattern having an index number somewhere between 4 and 5.

The continuously switchable beamforming can also be applied to other beamforming patterns. For example, adaptive directivity beamforming for a two-microphone array may be performed as follows.

The previously shown MVDR solution may be rewritten as,

$$w = \frac{1}{{a}^{H} {R}_{nn}^{- 1} a} {R}_{nn}^{- 1} a .$$

For a two-microphone array, the array steering vector has the following form (far-field model):

a(θₛ)=[1,φ*(θₛ)]^{H},

where φ is a phase factor and is function of target DOA θₛ, representing the phase shift with respect to the signal in the first microphone. Further, the noise correlation matrix Rₙₙ can be directly parameterized by a 2-by-2 normalized Toeplitz matrix as

$${Γ}_{nn} = [ \begin{matrix}1 & γ \\ {γ}^{*} & 1\end{matrix} ] ,$$

where is a correlation factor. By substitution, the optimal MVDR beamforming weights may be formulated as,

$$w = \frac{1}{2 - ( γφ + {γ}^{*} {φ}^{*} )} [ \begin{matrix}1 - γφ \\ - {γ}^{*} + φ\end{matrix} ] .$$

In some embodiments, it is assumed that the target DOA is fixed and therefore the phase factor φ is a constant. The set of “discrete” beamforming weights can be obtained by setting the correlation factor γ to several values within the range of [0, 1]. FIG. 10 plots the corresponding beampatterns at a frequency of 2000 Hz for a two-microphone array with 3 cm distances between the two microphones and with target DOA of 0 degree (end-fire). FIG. 10 illustrates a polar plot of beampatterns of discrete directivity beamforming.

FIG. 11 plots some of the beampatterns synthesized from the beamforming weights generated by the interpolation functions. FIG. 11 shows a polar plot of synthesized beampatterns for an embodiment of two-microphone switchable continuous beamforming.

FIG. 12 illustrates a flowchart of process 1250, which may be employed as an embodiment of the process 350 of FIG. 3. A dashed line in FIG. 12 separate the steps that occur in the design phase from steps that occur in normal operation. After a start block, the process proceeds to block 1251, where pre-designed beamforming weights are obtaining, each set of weights having a corresponding integral index number ξ. For the discrete case, pre-designed beamforming weights are stored in memory.

In the discrete case, processing continues to block 1254A, where beamforming weights are optimized from a cost function, to determine an optimal integral index number ξ*=argmin{∥w^{H}(ξ)x|²}, ξ=1,2, . . . Ξ. Processing then moves to block 1255A, where the set of weights corresponding to the determined optimal index number is selected.

The process then advances to block 1256, where beamforming is performed to generate beamforming output signal Y. The beamforming is accomplished by applying the selected set of weights to each subband of each signal and then combining the weighted signals. The processing then moves to a return block, where other processing is resumed.

In the continuous case, processing moves from block 1251 to block 1252, where the designer chooses a form of interpolation function f. The processing then proceeds to block 1253, where the interpolation function

$${f}^{0} = \{ {\sum }_{ξ = 1}^{Z} {\vert f ( ξ ) - w ( ξ ) \vert}^{2} , \} .$$

is computed, and the interpolation function along with the coefficients of the interpolation function are stored in memory. This is the last step in the design phase for the continuous case. The processing then advances to block 1254B, where beamforming weights are optimized from a cost function to determine an optimal index number, which need not be an integer. The processing then moves to block 1255B, where new beamforming weights are synthesized. The process then advances to block 1256.

The above specification, examples and data provide a description of the manufacture and use of the composition of the invention. Since many embodiments of the invention can be made without departing from the spirit and scope of the invention, the invention also resides in the claims hereinafter appended.

What is claimed is:

1. A method for beamforming, comprising:
storing a plurality of parameters that are based, at least in part, on a plurality of sets of pre-determined beamforming weights, wherein each of the sets of pre-determined beamforming weights has a corresponding integral index number;
for each input microphone signal of a plurality of input microphone signals, transforming the input microphone signal to the frequency domain to provide a corresponding transformed signal, wherein each of the transformed signals includes a plurality of subbands;
determining an index number representing an optimal set of beamforming weights for the transformed signals;
for each subband of each of the transformed signals, applying a set of beamforming weights that corresponds to the determined index number to provide a weighted signal; and
providing a time domain signal by combining each of the weighted signals.

2. The method of claim 1, where the sets of pre-determined beamforming weights correspond to at least one of: different null beamforming patterns, beampatterns with different looking directions, different end-fire directivity beampatterns, or beampatterns for different levels of diagonal loading.

3. The method of claim 1, wherein transforming the input microphone signal to the frequency domain is accomplished with a Short-Time Fourier Transform.

4. The method of claim 1, wherein each of the beamforming weights is a complex number.

5. The method of claim 1, wherein determining the index number representing the optimal set of beamforming weights for the transformed signals is performed over time such that the index number representing the optimal set of beamforming weights is updated over time.

6. The method of claim 1, wherein
the plurality of parameters is the plurality of sets of pre-determined weights, and wherein determining the index number representing the optimal set of beamforming weights for the transformed signals is accomplished by: generating a plurality of beamforming outputs by applying each set of the plurality of sets of pre-determined beamforming weights to the transformed signals, and selecting an optimal beamforming output among the plurality of beamforming outputs by comparing each of the plurality of beamforming weights with each other in accordance with at least a first selection criterion.

7. The method of claim 6, wherein the first selection criterion is at least one of minimal mean square error, minimal variance distortion-less response, maximal output signal-to-noise ratio, or maximal non-Gaussianity of the output.

8. The method of claim 1, wherein
the plurality of parameters are an interpolation function and the coefficients of the interpolation function;
determining the index number representing the optimal set of beamforming weights for the transformed signals is accomplished by:
determining the index number from a cost function based on at least a first criterion; and
wherein applying the set of beamforming weights that corresponds to the determined index number includes synthesizing a new set of beamforming weights based on the determined index number and the interpolation function.

9. The method of claim 8, wherein the interpolation function is at least one of polynomial, exponential, or Gaussian.

10. The method of claim 8, wherein determining the index number from the cost function based on at least the first criterion is accomplished employing a steepest-descent algorithm.

11. An apparatus for beamforming, comprising:
a memory that is configured to store a plurality of parameters that are based, at least in part, on a plurality of sets of pre-determined beamforming weights, wherein each of the sets of pre-determined beamforming weights has a corresponding integral index number; and
a processor that is configured to execute code that enables actions, including:
for each input microphone signal of a plurality of input microphone signals, transforming the input microphone signal to the frequency domain to provide a corresponding transformed signal, wherein each of the transformed signals includes a plurality of subbands;
determining an index number representing an optimal set of beamforming weights for the transformed signals;
for each subband of each of the transformed signals, applying a set of beamforming weights that corresponds to the determined index number to provide a weighted signal; and
providing a time domain signal by combining each of the weighted signals.

12. The apparatus of claim 11, wherein
the plurality of parameters is the plurality of sets of pre-determined weights, and wherein the processor is further configured such that determining the index number representing the optimal set of beamforming weights for the transformed signals is accomplished by: generating a plurality of beamforming outputs by applying each set of the plurality of sets of pre-determined beamforming weights to the transformed signals, and selecting an optimal beamforming output among the plurality of beamforming outputs by comparing each of the plurality of beamforming weights with each other in accordance with at least a first selection criterion.

13. The apparatus of claim 11, wherein the plurality of parameters are an interpolation function and the coefficients of the interpolation function, and wherein the processor is further configured such that:
determining the index number representing the optimal set of beamforming weights for the transformed signals is accomplished by:
determining the index number from a cost function based on at least a first criterion; and
applying the set of beamforming weights that corresponds to the determined index number includes synthesizing a new set of beamforming weights based on the determined index number and the interpolation function.

14. The apparatus of claim 11, further comprising:
a microphone array that includes a plurality of microphones, wherein the each microphone in the microphone array is arranged to receive sound, and to provide a microphone signal in response to the received sound;
a digital-to-analog converter that is arranged to provide the plurality of input microphone signals by converting each of the microphone signals into the input microphone signal.

15. A tangible processor-readable storage medium that arranged to encode processor-readable code, which, when executed by one or more processors, enables actions for beamforming, comprising:
storing a plurality of parameters that are based, at least in part, on a plurality of sets of pre-determined beamforming weights, wherein each of the sets of pre-determined beamforming weights has a corresponding integral index number;
for each input microphone signal of plurality of input microphone signals, transforming the input microphone signal to the frequency domain to provide a corresponding transformed signal, wherein each of the transformed signals includes a plurality of subbands;
determining an index number representing an optimal set of beamforming weights for the transformed signals;
for each subband of each of the transformed signals, applying a set of beamforming weights that corresponds to the determined index number to provide a weighted signal; and
providing a time domain signal by combining each of the weighted signals.

16. The tangible processor-readable storage medium of claim 15, wherein
the plurality of parameters is the plurality of sets of pre-determined weights, and wherein determining the index number representing the optimal set of beamforming weights for the transformed signals is accomplished by: generating a plurality of beamforming outputs by applying each set of the plurality of sets of pre-determined beamforming weights to the transformed signals, and selecting an optimal beamforming output among the plurality of beamforming outputs by comparing each of the plurality of beamforming weights with each other in accordance with at least a first selection criterion.

17. The tangible processor-readable storage medium of claim 15, wherein
the plurality of parameters are an interpolation function and the coefficients of the interpolation function;
determining the index number representing the optimal set of beamforming weights for the transformed signals is accomplished by:
determining the index number from a cost function based on at least a first criterion; and
wherein applying the set of beamforming weights that corresponds to the determined index number includes synthesizing a new set of beamforming weights based on the determined index number and the interpolation function.

18. A method for beamforming, comprising:
storing an interpolation function and coefficients of the interpolation function, wherein the interpolation is based, in part, on a plurality of sets of pre-determined beamforming weights, wherein each of the sets of pre-determined beamforming weights has a corresponding integral index number;
for each input microphone signal of a plurality of input microphone signals, transforming the input microphone signal to the frequency domain to provide a corresponding transformed signal, wherein each of the transformed signals includes a plurality of subbands;
determining an index number representing an optimal set of beamforming weights for the transformed signals;
re-synthesizing a set of weights that correspond to the determined index number to provide a weighted signal;
for each subband of each of the transformed signals, applying the re-synthesized set of beamforming weights; and
providing a time domain signal by combining each of the weighted signals.

19. The method of claim 18, wherein determining the index number representing the optimal set of beamforming weights for the transformed signals is accomplished by: determining the index number from a cost function based on at least a first criterion employing a steepest-descent algorithm.

20. The method of claim 18, further comprising:
prior to storing the interpolation function and coefficients of the interpolation function, computing the interpolation function, wherein computing the interpolation function is accomplished by minimization of mean square error.
